(19) United States
(12) Patent Application Publication
(10) Pub. No.: US 2008/0021877 A1
(43) Pub. Date: Jan. 24, 2008

(54) Medical image processing system in a wide-area network environment

(75) Inventors: Motoaki Saito, Tokyo (JP); Kazuo Takahashi, Tokyo (JP)

Correspondence Address: BLAKELY SOKOLOFF TAYLOR & ZAFMAN, 1279 OAKMEAD PARKWAY, SUNNYVALE, CA, 94085-4040, US

(73) Assignee: TeraRecon, Inc., San Mateo, CA (US)

(21) Appl. No.: 11/490,964

(22) Filed: Jul. 20, 2006

(51) Int. Cl. G06F 17/30

(52) U.S. Cl. 707/3

(57) ABSTRACT

In a system in which data processing devices are set up in the vicinity of or directly connected to data archiving devices of a plurality of medical image systems, image data and image processing parameters are specified from user terminal devices connected to the network. Image data specified by data processing devices is acquired, specified image processing operations are performed and the results of the image processing are sent to user terminal devices. The user terminal devices receive results of image processing from multiple data processing devices, image processing operations such as superimposition and fusion are conducted, and the results are displayed. Image processing operations therefore can be applied to image data stored in data archiving devices of multiple facilities for medical treatment using data processing devices in the vicinity without acquisition through the network.

### FIELD OF THE INVENTION

This invention relates to an image processing system, which can be used for medical image data accumulated in a wide-area network environment such as the Internet.

### BACKGROUND

Information relating to medical image scans, which represents one part of information relating to the diagnosis and treatment of patients, is of paramount importance. Medical image scans are generally conducted in medical departments where image diagnosis is performed with devices such as X-ray devices, X ray computed tomography (CT) devices, nuclear medicine diagnostic devices, ultrasonic wave diagnostic devices, endoscopic devices and similar devices for medical diagnosis. Medical images collected with these medical diagnosis devices are in many cases used when an image diagnosis is performed during a process called imaging by specialists who specialize in image diagnosis. The result of an image diagnosis is then described in a written image diagnosis report and transmitted to departments which requested such a transmission.

When X-ray images were taken in the past with an X-ray machine, it was possible to observe the images that were collected with a medical image diagnosis device, such as an X-ray CT device or a similar device provided with the digital design, and it was also possible to print these collected medical images onto a film for observation. In recent years, in order to improve storage and distribution of medical images, digital data containing medical images has been stored on servers so that the data could be distributed to image display devices through a network as necessary, and picture archiving and communication systems (PACS) have been installed in many medical treatment institutions for observation of medical image data used with the image display devices.

The high performance characteristics of image diagnosis devices such as X-ray CT devices were also accompanied by a rapid increase in the capacity of the data contained as image data generated with a single scan. That is why medical image data acquired with a medical diagnosis device is stored and archived in PACS data storage devices, distributed through a network to image display devices, and generally observed so that image display devices are used to observe this medical image data.

Positron emission tomography (PET) is a type of medical image diagnosis device that has recently received significant attention. As scanning is widely conducted with PET scans, a medical agent provided with a marker consisting of attached positron nuclides is injected into the vein so that it is integrated by the bodily system. This marker is then photographed with a PET device and the conduct of the agent then creates functional images which are collected by an image diagnosis device. Because one can assume that cancerous cells are present in locations containing multiple abnormal accumulations of glucose, this is an effective cancer scanning method. In addition, functional scans for cancer and other head scans are thus also effective as scans which can be applied to patients with ischemic diseases and other diseases. However, because this equipment is expensive and because handling of isotopes remains problematic, so called PET centers have been in many cases introduced only in specialized medical treatment institutions and not in general hospitals.

Therefore, in cases requiring that the patient be admitted to a hospital which was not equipped with a PET device, or if the patient has to visit such a hospital, the patient had to go to a PET center for a PET scan when a PET scan was required. The scan was then carried out at a PET center in which the patient was examined with a PET device, the obtained PET image data was used for imaging, the results of this imaging were described in an imaging report and this imaging report and key images were burnt onto a film, etc., which were then transmitted to the main doctor responsible for the treatment in the hospital in which the patient was normally examined. The doctor responsible for the normal diagnosis and treatment of this patient was thus able to come to an understanding of the condition of the patients based on this imaging report and the key images burnt onto a film, which were very useful for diagnosis and treatment of patients.

Many medical treatment institutions are equipped not only with PET devices, but also with expensive and large X-ray CT devices and magnetic resonance (MR) devices. Therefore, if patients who are admitted to a hospital or who went to a hospital which does not have these X-ray CT devices were MR devices needed to be examined with an X-ray CT scan or an MR scan, they had to be examined at a major hospital or at a specialized medical treatment facility called an image center which has X-ray CT or MR devices so that an X-racy CT scan or an MR scan could be performed. Once a scan has been carried out using an X-ray CT device or an MR device so that the patient was examined in a large hospital or at an image center, the X-ray CT image data obtained with the scan and MR image data was used to perform imaging, the imaging results were described in an imaging report, and this imaging report and key images were burnt onto a film or the like and transmitted to the main doctor responsible for the treatment at the hospital in which the patient was normally diagnosed and treated. The doctor responsible for the normal diagnosis and treatment of this patient was thus able to come to an understanding of the condition of the patients based on this imaging report and based on the key images burnt onto a film, which were very useful for diagnosis and treatment of patients. In this manner, medical treatment facilities such as diagnostic departments in which a patient was normally examined and treated were up until now generally cooperating with medical treatment facilities that were equipped with PET devices, X-ray CT device, MR-devices and other advanced equipment enabling to perform medical image diagnosis.

The image data that was collected with PET devices, X-ray CT devices, MR devices, etc., at the PET centers or imaging centers mentioned above was then stored in PACS data archiving devices so that the data could be read as required from these data archiving devices and displayed on image processing workstations, three-dimensional image processing was then applied with various types of image processing operations and imaging operations were performed enabling to view the details of the images.

Incidentally, because imaging reports and key images were sent from a PET center or from an imaging center to the main doctor responsible for the treatment at the hospital where the patient was normally treated and various reports and images were burnt onto a film, the doctor responsible for the treatment of the patient was generally unable to observe directly the PET image data, X-ray CT image data or MR image data that was used for imaging by the image specialist at the PET center or image center.

The doctor in charge of the treatment thus used an available image processing workstation, which made it possible to observe image data obtained at an image processing workstation when PET image data, X-ray CT image date and MR image data was acquired from a PET center or an image center via a wide-area network such as the Internet. However, due to the large amount of PET image data, X-ray CT data and MR image data, which means that several hundred megabytes of data were eventually created and collected for example with the latest X-ray CT scans as X-ray CT image data, the acquisition of the data via a wide-area network such as the Internet was not a realistic expectation. Although the image data can be recorded on a CD or a DVD or a similar medium and mailed in order to solve this problem, the problem was that this was not a very prompt system.

When a doctor who was in charge of treatment at a request origination facility was using a user terminal device according to the prior art, a database of multiple medical image systems of multiple medical treatment facilities on a network was searched, so that when the image data of a desired examination was selected, all of the image data of this examination was then transmitted through a wide-area network from a data archiving device in which this image data was archived to a user terminal device. For example, when three-dimensional image data was created with 1,000 pages of X-ray CT image data obtained in one examination, this was not a realistic design, because data corresponding to 500 MB was to be transmitted through a wide-area network.

### SUMMARY OF THE INVENTION

The present invention includes a medical image system on a wide-area network. In certain embodiments, the medical image system comprises a data archiving device to store medical image data, and a data processing device coupled to the data archiving device. The data processing device is to receive, from the data archiving device, image data identified in a request sent by a user terminal device over the wide-area network, to generate medical images by processing the identified image data based on image processing parameters sent by the user terminal device over the wide-area network, and to transmit the medical images to the user terminal device over the wide-area network, without transmitting the identified image data to the user terminal device over the wide-area network.

Other aspects of the invention will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 is a block diagram of a medical image processing system in a wide-area network environment according to an embodiment of this invention;

FIG. 2 shows the flow of data in an embodiment of this invention; and

FIG. 3 shows the flow of data in another embodiment of this invention.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

### Overview of Solution

The solution introduced here is realized with a medical image system equipped with data archiving devices installed in multiple medical treatment facilities, and with data processing devices installed in the vicinity of a network, or directly on one or more data archiving devices, wherein user terminal devices, set up in medical treatment facilities, are also mutually connected with a wide-area network such as the Internet. The user terminal devices are equipped with a function enabling to specify image processing parameters executed with data processing devices and to specify image data to be obtained from a data archiving device, while at the same time, data processing devices deployed near a network of the data archiving device of a medical image system are used for storage of desired image data. When the data processing devices acquire the specified image data from the data archiving device, image processing is carried out with the image processing parameters that have been specified for this image data and the data is transmitted from the data processing devices of the medical image to terminal devices of users as image data with the results of image processing operations. When the user terminal devices receive image data processed with image processing operations that has been transmitted from the data processing device of one or more medical image systems, this data containing these processed images is used for superimposition of images and similar image processing operations, so that a resulting image is displayed after image processing operations with the display function. Therefore, image diagnosis supporting operations, including mutual comparison of image data dispersed and archived in a plurality of medical image system, can be performed so that all the related image data can be realized, without transmitting all of the image related data via a wide-area network, in an image processing system realized with a wide-area network, in which only image data containing the results of image processing is transmitted.

The data archiving devices are equipped with a function enabling to transmit specified image data to data processing devices, and with a function enabling to archive medical image data collected with image diagnosis devices. The database is provided with a function enabling to manage data archived in data archiving device, so that this database can be searched as an independent database based on inquiries obtained from the users of terminals. The data processing devices perform image processing operations based on data parameters of image data specified with user terminal devices with a function enabling acquisition of data from image archiving device, so that the image data is transmitted with the transmission enabling function of the system to the user terminal devices. In addition, the medical image system is also equipped with a user authentication function. The user terminal devices are equipped with an inquiry function, wherein a inquiry relating to medical image data stored in data archiving devices of a medical image system is sent to the database of multiple medical image systems on a wide-area network, and one or more medical image systems are selected on a wide-area network based on the response obtained from the database in response to this inquiry; with an indication function, indicating that image processing operations are to be performed with image processing parameters indicted for this image data with the indication function, when image data is obtained from data archiving devices indicated for data processing devices of a selected medical image system. In addition, the data processing devices receiving image data containing transmitted processed images are equipped with a display function for displaying of the images obtained as a result of this image processing, and with an authentication function for the authentication of the user. Therefore, these user terminal devices can be used to receive via a wide-area network image data containing the results of desired image processing operations applied to desired image data selected from medical image data distributed to and archived in a plurality of medical image systems on a wide-area network; so that image diagnosis support operations, including items such as mutual comparison of image data sets distributed to and archived in multiple medical image systems, can be realized with an image processing system using a wide-area network enabling to transmit only image data resulting from image processing operations, without transmitting all related image data through a wide-area network.

Because user terminal devices can be used for image processing operations with interactive operations from one user terminal unit using data processing devices of a medical image system in which image data has been archived, without having to acquire image data through a wide-area network (such as the Internet), this makes it possible to use multiple image data resources distributed to and stored in one or more medical image systems, including mutual comparison of image data sets using multiple image data resources with processed images received from one ore more data processing devices, without an increase of image diagnosis support operations, and without an increase of the traffic in the network.

Since terminal user devices perform desired image processing operations by using multiple medical image data sets archived in data archiving devices of one or more medical image systems, image processing operations are conducted with interactive operations from one user terminal device using data processing devices of a medical image system in which respective image data sets are archived without having to acquire via a wide-area network or through the Internet this image data, so that by performing image processing operations such as fusion processing or superimposition with user terminal devices applied to multiple image data sets containing processed images received from one or more data processing devices, processing can be conducted with superimposition of multiple image data sets distributed to and archived in one ore more medical image system and similar image diagnosis supporting operations, without an increase in the network traffic.

Because user terminal devices performing desired image processing operations using multiple medical image data sets distributed to and stored in data archiving devices of multiple medical image systems on a network that can be used for image processing using data processing devices of a medical image system, in which this image data is stored without acquiring image data through a network, data processing devices can be used for manual or automatic repeated reception of the results of image processing with corrected image processing parameters, based on the results of image processing operations such as fusion processing and various types of superimposition processing, realized at the user terminals and applied to multiple image data sets containing processed images received from one or more user processing devices. Therefore, a wide range of image diagnosis support operations, including superimposition processing and fusion processing applied to multiple image data sets distributed to and stored in one or more medical image system, can be performed without an increase in the network traffic.

User terminal devices perform desired processing of image operations using multiple sets of medical image data distributed to and stored in data archiving devices of one ore more medical image system on a network perform image processing operations, while using data processing devices of medical image systems in which this image data is stored, and information obtained the result of various types of data processing operations, realized with user terminal devices applied to multiple image data sets containing processed images received from one or more data processing devices is transmitted to the corresponding data processing devices. The image processing parameters of data processing devices used for the determination of data processing devices can be modified so that when the results of these operations are repeatedly received again, image diagnosis supporting operations, such as superimposition and fusion of multiple image data sets distributed to and stored in one ore more medical image systems, can be conducted without an increase in the network traffic.

User terminal devices performing desired processing of images applied to multiple medical image data sets stored in data archiving devices of one or more medical image systems on a network, described in image diagnosis reports created by medical image and imaging specialists, can be thus used to perform image processing operations using image processing parameters described in image diagnosis manuals, while using data processing devices of a medical image system in which image data sets are stored as described in image diagnosis reports. Image reference can thus be provided using multiple image data sets distributed to and stored in one or more medical image systems, including mutual comparison of image data sets containing multiple image data sets with processed images received from one or more data processing device, without an increase of the network traffic in a wide-area network or the like.

### Effect of the Invention

According to embodiments of this invention, a medical image processing system in a wide-area network environment is set up as a medical image system in which data processing devices are connected directly to data archiving devices, or deployed in the vicinity of a network, while a database is created for data archiving devices in which image data collected for example with PET devices is stored, for example in a PET center. Because a database is created and data archiving devices are set up in which image data collected with devices such as X-ray CT devices or MR devices is stored, a medical system is created in which data processing devices are connected directly to data archiving devices, or they are set up in the vicinity of a network. Moreover, user terminal devices are set up in medical facilities such as a diagnostic facility in which patients are normally examined, which are mutually connected using Internet or a wide-area network or the like. Based on a determination of the doctor in charge who is performing daily examinations of patients, a patient is examined with a PET scan, or an X-ray CT scan, or an MR scan at a PET center or an image center. Imaging operations are performed with the PET image data, X-ray CT image data, or MR image data by an image diagnosis specialist at a PET center or an image center, an imaging report is prepared, and various types of processing operations using key images and imaging can be conducted based on possible image processing parameters transmitted as e-mail or the like to the doctor in charge at the medical treatment facility who is normally responsible for the treatment of a given patient.

When a doctor in charge of treatment who has received an imaging report reads an imaging report using a user terminal device accesses via Internet or a wide-area network or the like a medical image system at a PET center or an image center in which a patient has been examined, the image data for examination of the patient is specified, and by transmitting to a data processing device in a PET center or an image center, the possible image processing parameters are specified so that various types of image processing operations can be conducted again using key images and imaging selected by a medical image specialist, the image data stored in data archiving devices of a PET center or image center is used, various types of image processing operations are applied by medical imaging specialists using data processing devices at a PET center or image center, and images provided as a result of image processing are received through a wide area network or Internet or the like, so that these images can be displayed on user terminal devices. In this case, when image processing operations are performed with a data processing device of a PET center or an image center using image data stored at a data archiving device of a PET center or an image center and only the results are received through a wide-area network or the like, while image data stored at a data archiving device at a PET center or an image center is received through a wide-area network, the network traffic can be greatly decreased when compared to a case in which image devices are used with image processing workstations that are made available to a doctor in charge of the treatment.

Based on a determination of a doctor in charge who normally treats a patient, a patient is examined at a PET center or at an image center with a PET scan, an X-ray CT scan or an MR scan. The doctor in charge of the treatment can access a PET center or an image center through a wide-area network such as the Internet using a user terminal device. Because the doctor in charge can therefore view the PET image data of a patient which is stored at a PET center by using a user terminal device, as well as access X-ray CT image data or MR image data stored at an image center, image processing can be conducted using data processing devices of a medical image system at a PET center, applied to PET image data, or data processing device of a medical image system at an image center, and applied to X-ray CT image data or MR image data, and because the result of the image processing can be received, image processing operations such as superimposition processing or fusion processing of X-ray CT image data or of MR image data stored at a PET image center or an image center can be performed while the parameters can be changed in an interactive manner and the results can be displayed on one unit represented by the image display device of a user terminal.

### EXPLANATION OF REFERENCE NUMERALS

101 Internet or another type of a wide-area network
201, 202, 203, 204, 205 facilities for medical treatment
211 user terminal device
212 console
213 display device
221 medical image system
222 data archiving device
223 database
224 data processing device
225 high-speed network
231 connection device
232 internal network of an institution for medical treatment
233 network for image data
241, 242 image diagnosis device
301 image data inquiry
302 image data inquiry
303 response to an image data inquiry
304 response to an image data inquiry
305 image data acquisition request
306 image data acquisition request
307 image data transmission request
308 image data
309 image data processing parameters
310 image data processing parameters
311 image data with processed images
312 image data with processed images
325 user terminal substitution device
401 database search
402 database search
403 image processing
404 image processing and image display

### EMBODIMENTS OF THE INVENTION

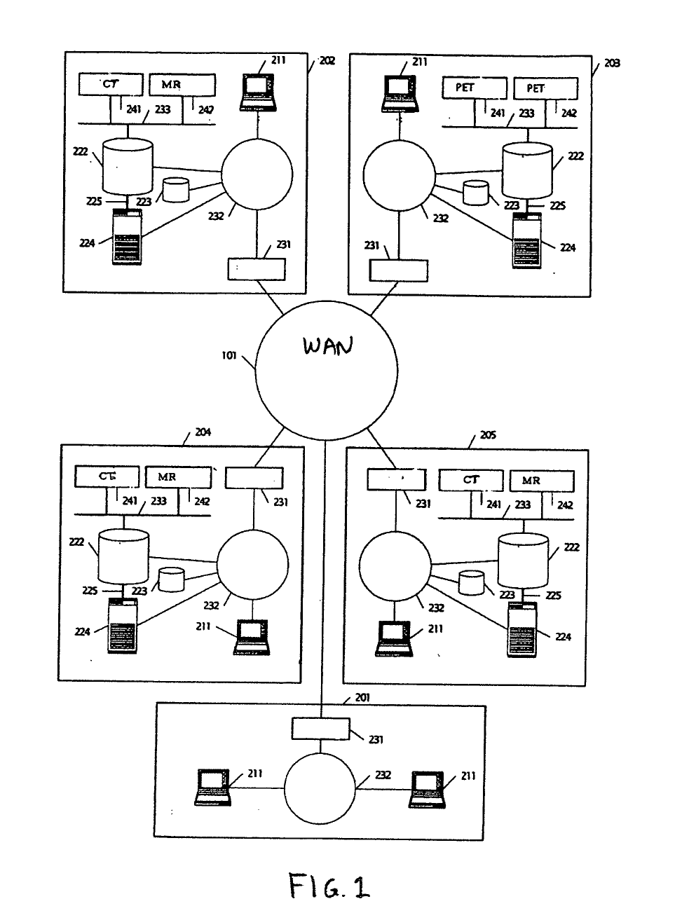

FIG. 1 is a block diagram showing a medical image processing system in network environment of this invention, wherein element 101 is a wide-area network such as the Internet. Elements 201, 202, 203, 204, 205 are medical treatment facilities, elements 202, 203, 204 are PET centers or image centers, and it is assumed that medical treatment facility 201 is an examination and treatment institution representing a main hospital. The medical treatment facilities 201, 202, 203, 204, 205 are connected to a wide-area network 101, which can be, for example, the Internet. Element 231 is a connection device connecting a medical treatment facility with an internal wide-area network of a medical treatment facility. Element 232 is an intranet, i.e., an internal network of a medical treatment facility.

Element 222 is a data archiving device, which archives medical image data; element 232 is a database; element 224 is a data processing device; element 225 is a high-speed network connecting data processing devices with data archiving devices; and element 233 is a high-speed network for image data. Elements 241 and 242 are image diagnosis devices and element 211 is a personal computer which is used as a user terminal device.

X-ray imaging data is collected for multiple profiles of an examined patient with an X-ray CT device 241, which is one example of an image diagnosis device, at a medical treatment facility 202, and image data comprising multiple profiles is realized with image reconstruction processing applied to this X-ray imaging data. The data archiving device 222 stores image data created as image reconstruction data collected with multiple image diagnosis devices, beginning with from X-ray CT device 241, so that the data can be transmitted as necessary to a user. The network 233 is a high-capacity and high-speed network for transmission of large amounts of image data from the X-ray CT device 241 to the data archiving device 222. The data processing device 224 acquires image data which is stored by the data archiving device 222 so that this data is then processed to create two-dimensional, three-dimensional, and four dimensional images. A medical image diagnosis specialist, who performs image diagnosis using a personal computer 211, specifies image diagnosis parameters to perform an image diagnosis and issues instructions for image processing parameters to the data processing device 224. The data processing device 224 collects the specified image data from the data archiving device 222 and creates an image by performing image processing operation indicated for this image data, so that the created images are then transmitted to the personal computer 211. An image diagnosis specialist can thus specify image data using a personal computer 211 and monitor the preparation of two-dimensional images using this image data, and the specialist can also monitor the preparation of three-dimensional images and four dimensional images.

FIG. 1 illustrates the situation when an image diagnosis specialist at a medical treatment facility 202, which is one example of a medical treatment facility, performed medical image diagnosis. This will be the same situation also at a medical treatment facility 203, medical treatment facility 204, or medical treatment facility 205. A patient's X-ray CT image data, or recorded with the X-ray CT device 241, is sent through the network 233 and stored in data archiving device 222. A medical image diagnosis specialist performing a medical image diagnosis uses a personal computer 211 at a user terminal device so that the X-ray CT image data of this patient can be specified for the data processing device 224, directly connected to the data archiving device 22 in which the image data is stored, or set up in the vicinity of its network, and this information is transmitted. When the data processing device 224 has received information relating to the X-ray CT image data of a giving patient, the specified X-ray CT image data is acquired from the data archiving device 22 based on this information, image processing is performed based on the instructions relating to the image processing that have been sent by a medical image diagnosis specialist from the personal computer 211, and image data containing the results of the processing is sent to the personal computer 211. When the images are received, the personal computer 211 will display these images. A medical image diagnoses specialist observes images displayed by a personal computer 211, and when this is desired, modifies image processing parameters and this is then transmitted to data processing device 234 so that the images can be displayed processed according to new image processing parameters while these image processing parameters can be updated in an interactive manner.

Image data and image processing results, obtained as a result of image processing in one example of images for example with image processing applied to X-ray CT image data, can be obtained in an example of two-dimensional image processing as 16-bit X-ray CT image data with window processing, the result is obtained as a gray scale image with 256 shades of gray, while in an example of three-dimensional image processing, volume rendering is applied to multiple 16-bit X-ray CT image data sets, so that the results obtained in this manner can be can be used to create a color image with 256 intensity levels, etc.

A medical image diagnosis specialist monitors the image processing of two-dimensional images and the preparation of three-dimensional images so that an image diagnosis report is prepared based on these findings contained in an electronic medical record using the personal computer 211. Key images, which form the basis for the findings of an image diagnosis report, are added at this point. In addition, a set of image processing parameters is also added to the image diagnosis report, which was used to create images representing the basis for the finding of the image diagnosis report. This includes parameters specifying key images selected from a large amount of image data, as well other image processing parameters used to display an optimal mode of the images, or parameters used to create three-dimensional images and the like.

An image diagnosis report created by a medical image diagnosis specialist can be either distributed to the request destination via an internal hospital network if the requesting party is located within the same hospital, or the report can be recorded off-line on a media such as an IC card and distributed by mail. If the requesting party is located in another medical treatment facility, an image diagnosis report can be either distributed by transmitting an encrypted file to a personal computer which is connected through a wide-area network, Internet, etc., or so that the image diagnosis report is encrypted and recorded on an IC card or a similar media and sent by mail.

FIG. 1 shows the situation in a case where 201 indicates a facility where a request originated. Medical treatment facility 202, medical treatment facility 203, medical treatment facility 204 and medical treatment facility 205 are also in the same situation. The doctor who is in charge of treatment inspects a medical diagnosis report distributed using a personal computer 211. In order to access an image diagnosis report from this personal computer, authentication must be received with an authentication system using an IC card or the like.

When the doctor who is in charge of the treatment at the facility where a request originated (request origination facility) browses an image diagnosis report using a personal computer 211, a set of image processing parameters is attached to the information relating to the image data, which is attached to an image diagnosis report by clicking on key images attached to an image diagnosis report, and sent from the personal computer 211 to the data processing device 224 of the request origination facility 202. When this is received, the data processing device 224 acquires image data from the data archiving device 222, an image is created by applying image processing operations to this image data, and these images are encrypted and transmitted to the personal computer 211 using a user terminal device of the request origination facility 201. When these encrypted images are received by the personal computer 211 of the user terminal device of the request origination facility 201, these images are decoded and displayed. In addition, because the modified image processing parameters are sent to the data processing device 224 of the request destination facility 202, the images can be received with new image processing parameters, while the images can be updated in an interactive manner.

Accordingly, this makes it possible to achieve a better understanding of the image diagnosis report.

Although it has been explained thus far that as shown in FIG. 1, a doctor in charge of the treatment at the request origination facility 201 was browsing image data of a patient examined with an X-ray CT scan at the medical treatment facility 202, the same arrangement can be also used to browse, with user terminal device 211 of the request origination facility 201, at the same time the image data of a PET scan of the same patient, who was examined at the medical treatment facility 203. When an instruction is issued from the same user terminal device for the medical image system of the medical treatment facility 202 and medical treatment facility 203, image processing operations can be applied at the same time to the X-ray CT image data and PET image data using the data processing device 224 of the medical image system of the medical treatment facility 202 and of the medical treatment facility 203. Therefore, when a patient is examined at a PET center, image processing related to the PET image data stored at the PET center is performed, and when a patient is examined at an image center, image processing related to the X-ray CT image data stored at the X-ray image center is performed at respective data processing device 224 so that only the image data representing the result of the image processing operation is received, making it possible to perform superimposition processing or fusion processing operations which can be applied at the user terminal device 211 to PET images or X-ray CT images.

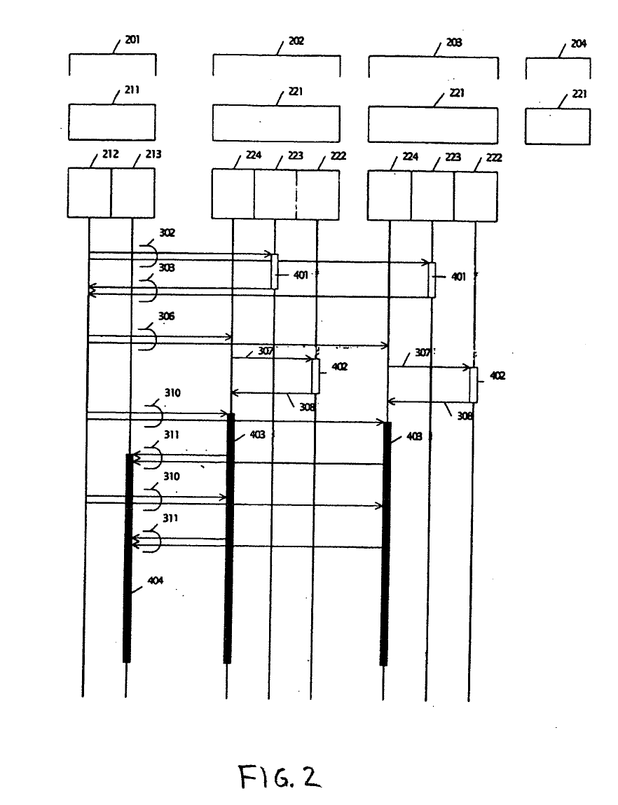

The flow of data with the operation used up until this point will be explained next with reference to FIG. 2. FIG. 2 explains a case where facility 201 is a facility in which a request originated. In this case, by clicking on a key image attached to an image diagnosis report, information relating to image data attached to an image diagnosis report is transmitted together with an image data acquisition request 306 and with image processing parameters from a personal computer 211 to a data processing device 224 of the request destination facility 202 or 203. Data processing device 224 of the request destination facility 202 or 203 which received this information then transmits a data transmission request 307 to the data archiving storage 222. When the data transmission request 307 is received, the data archiving device 222 reads image data 308 and this image data 308 is transmitted to the data processing device 224. The data processing device 224 performs image processing operations applied to this image data and encrypts the image data 311 which is obtained as a result of image processing, and this information is sent to the user terminal device 211 of the request origination facility 201. The personal computer 211 of the user terminal device of the request origination facility 201 receives encrypted images 311 and these images are decoded and displayed. In addition, by sending modified image processing parameters 310 to the request destination facility 202 or 203 with the data processing device 204, the results of processed images can be received as image data 311 with new image processing parameters, while the image processing parameters can be modified in an interactive manner.

While the explanation pertained to a case where image data was acquired based on information relating to image data attached to an image diagnosis report, image data can be accessed as required also based on information relating to a patient by a doctor in charge at the request origination facility without an image diagnosis report. As shown in FIG. 2, the doctor in charge of treatment at the request origination facility 201 uses a user terminal device 211 to perform an image data inquiry 302 under conditions applicable to a desired database 223 of multiple medical image systems 221 in multiple medical treatment institutions on a wide-area network.

For example, patient A inquires about image data relating to PET scans, X-ray CT scans, and MR scans form examinations when this patient was examined from Jan. 1, 2004 to Mar. 31, 2004. When an image data inquiry 302, which has been sent from a user terminal device 211, is received in the database 223 of the medical image system of medical treatment facilities 202, 203, 204, a search is run to determine whether image data matching the conditions of the inquiry is stored in the data archiving device 222 and the results of the search are returned to the user terminal device 211 as a response 303 to the inquiry, the user terminal device 211 will display this response and the doctor in charge of treatment selects the image data of the desired examination, so that a data acquisition request 306 will be sent to a data processing device in the vicinity of the data archiving device 222 in which the image data of the desired examination is stored. If for example the image data of a desired X-ray CT scan is archived in the data archiving device 222 of the medical image system 221 of the medical treatment facility 203, when desired PET scan data is stored in the data archiving device 222 of the medical image system 221 of the medical treatment facility 203, an acquisition request 306 for desired X-ray CT scan image data is sent to data processing device 224 of the medical image system 221 of the medical treatment facility 221 by a user terminal device 211, and an acquisition request 306 is sent for the acquisition of desired PET scan image data to the data processing device 224 of the medical image system 221 of the medical treatment facility 203. The data processing device 224 of the medical image system 221 of the medial treatment facility 203 transmits to the data archiving device 222 a transmission request 307 for the specified X-ray CT scan image data and image data 308 is obtained. Image processing operations will be performed in response to this according to image processing parameters 310 specified from the user terminal 211, and the processing results 311 are sent to the user terminal device 211.

The doctor in charge of the treatment at the request origination facility searches the database of a plurality of medical image systems of multiple medical treatment facilities on a wide-area network using a user terminal device 211, the image data of a desired examination is selected, desired image processing operations are applied to this image data using a data processing device which is in the vicinity of the network or directly connected to the data archiving device in which this image data is archived, so that only images representing the result of the image processing operations will be received through a wide-area network. If, for example, a three-dimensional image is created with X-ray CT image data containing 1,000 pages obtained with one examination, image data using three-dimensional image processing corresponding to as much as 500 MB of data will created. However, since according to this invention, image data is transmitted through a wide-area network with about 500 kB for each processing command, the result of the processing can be received while image processing parameters can be modified in an interactive manner.

When a doctor who was in charge of the treatment at the request origination facility 201 was using the user terminal device 211 according to the prior art, the database of multiple medical image systems of multiple medical treatment facilities on a network was searched so that when the image data of a desired examination was selected, all of the image data of this examination was then transmitted through a wide-area network from a data archiving device in which this image data was archived to a user terminal device. For example, when three-dimensional image data was created with 1,000 pages of X-ray CT image data obtained in one examination, this was not a realistic design because data corresponding to 500 MB was to be transmitted through a wide-area network.

According to this invention, data is collected with a data image processing device which is in the vicinity of a network, or directly connected to a data archiving device in which data containing two-dimensional, three-dimensional, and four-dimensional data requiring a large amount of image data is stored, and because the result of these image processing operations is then distributed through a wide-area network to the personal computer of a user terminal at the request origination facility, the traffic in the wide-area network will not be increased very much.

Cases in which both the request origination facility and request destination facility are in the same medical treatment facility are also included. In this case, an internal network such as intranet existing at the medical treatment facility can be used instead of using a wide-area network such as the Internet, etc. In such a case, the traffic in the internal network of the medical treatment facility will be greatly decreased.

At the user terminal device of a wide-area network such as the Internet, without transmitting image data archived in a data archiving device of multiple medical image system on a wide-area network to a user terminal device through a wide-area network, the image data can be displayed while image processing operations can be performed in an interactive manner using data processing devices set up in the vicinity of the network, or connected directly to a data archiving device. Because of that, image diagnosis supporting operations are enabled, without an increase of the traffic in the network, using image data distributed to and stored in multiple medical image systems, including mutual comparison of image data sets.

When desired image data processing operations are performed using data processing devices which are set up in the vicinity of or directly connected to data archiving device, so that image processing is applied to multiple medical image data sets archived in data archiving devices of multiple medical image systems on a wide-area network, since the data can be received through a wide-area network when the image processing of the data has been finished, image data that has been distributed to and stored in data archiving device of multiple medical image systems can be displayed on one image display device unit, while image processing operations can be applied in an interactive manner to the image data, so that image diagnosis support operations, including mutual comparison of image data sets, can be performed without acquiring all the related image data via a wide-area network.

When image processing operations, specified from a user terminal device using a data processing device set up in the vicinity of or directly connected to data archiving device, are applied to multiple medical image data sets which are archived in data archiving device of multiple medical image systems on a wide-area network, image data processed with image processing operations can be received via a wide-area network, and by conducting processing operations such as superimposition or fusion processing, applied to multiple received data sets in which image processing operations have been completed, multiple image data sets, distributed to and archived in multiple medical image systems, can be mutually superimposed, and fusion processing and other types of image processing operations can be performed so that the image can be displayed on one image display device while the parameters can be modified in an interactive manner, without transmitting all the related image data through a wide-area network.

User terminal devices are used to apply desired image processing operations to multiple image data sets archived in data archiving device of one or more medical image systems on a network, described in an image diagnosis report created with medical imaging, so that image processing operations are performed using image processing parameters described in an image diagnosis report using data processing devices of a medical image system in which medical data described in an image diagnosis report is described. This includes operations such as mutual comparison of image data sets used in multiple image data sets, wherein the image processing has been finished while the data has been received from one or more data processing device. Therefore, medical images can be referred to using multiple image data sets, which have been distributed to and archived in one or more medical image systems, without increasing the traffic in the network, such as a wide-area network, etc.

### First Alternative Embodiment

The following is an explanation of another embodiment of this invention. This example, which relates to a medical image system set up in a plurality of medical institutions, is equipped with data archiving devices and with data processing devices, set up in the vicinity of a network, or directly connected to these data archiving devices. User terminal substitution devices, equipped with a function substituting for a user terminal, are used to perform an inquiry function relating to image data archived in data archiving devices of a medical system, sent to a database of multiple medical image systems on a wide-area network based on instructions obtained from user terminal devices; equipped with a transmission function for transmission of a response obtained from a database as a response to an inquiry to user terminal device; with a display function for displaying of image data specified by a user terminal device for a data archiving device of one or more medical image systems on a wide-area network selected with a user terminal device, sent to a data processing device of this medical image system; with a specifying function, which specifies image processing operations to be performed with image processing parameters specified by a user terminal device for image data received for a data processing device; and with a transmission function for the transmission of image data received when the image processing operations for transmission by a data processing device have been finished. The data archiving devices are provided with a function enabling to archive medical image data collected with an image diagnosis data in a data archiving device, and with a function enabling to deliver to data processing devices image data specified with a user terminal device or with a user terminal substitution device.

A database, which is searched with an independent database search based on an inquiry from a user terminal device or a user terminal substitution device, is equipped with a data management function for management of data archived in a data archiving device, and is equipped with a function providing a response to a user terminal device or to a user terminal substitution device with the result of this search. A database processing device is equipped with a function for processing of images based on image processing parameters specified with a user terminal device or with a user terminal substitution device, and with a transmission function transmitting to a user terminal device or a user terminal substitution device image data obtained with image processing. User terminal devices are equipped with a function enabling to perform an inquiry relating to image data archived in a medical image system data archiving device, so that an inquiry can be performed via a directly connected user terminal substitution device in a database of multiple medical image systems on a network; and with a function indicating on a directly connected device or on a user terminal substitution device of a selected medical system the selection of one ore more medical image systems on a wide-area network based on a response obtained from the database to this inquiry, so that image data of a specified data storage device of the selected medical image system will be sent; a specifying function, specifying that image processing is to be performed with a directly connected user terminal or a user terminal substitution device image processing parameter specified for image data received in a data processing device; a function enabling to display data, after image data processing operations have been completed of the image data sent by a data processing device, as well as a user authentication function, authenticating the users. Because of that, user terminals, which are used to perform image processing operations with data processing devices set up in the vicinity of a network of data archiving device, applied to image data archived by data archiving device of the medical image system in multiple medical treatment facilities, can be used to display the results of image processing operations, sent by the data processing devices. When a user terminal device receives via a wide-area network the result of desired image processing operations applied to medical image data distributed to and stored in multiple medical image systems on a wide-area network, image diagnosis operations can be performed using image data that has been distributed to and stored in multiple medical image systems, including mutual comparison of image data sets distributed to and stored in multiple medical image systems without transmitting all the related image data through a wide-area network, because only image data resulting from image processing operations can be transmitted.

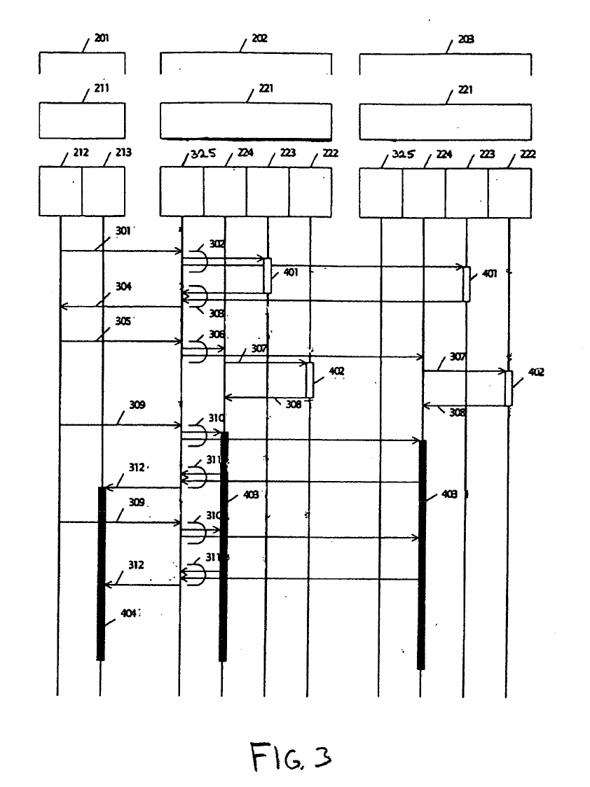

FIG. 3 is a diagram explaining the flow of data in another embodiment of this invention. As shown in FIG. 3, when a doctor in charge of treatment at request origination facility 201 uses a user terminal device 211 to request that an inquiry be performed for data under desired conditions in a database 223, so that a request 301 is issued by a user terminal substitution device 325 of a specified medical image system 221 on a wide-area network. For example, an inquiry is made for image data relating to PET scans, X-ray CT scans, and MR scans of patient A who has been examined from Jan. 1, 2004 to Mar. 31, 1004. A user terminal substitution device 325 generates an inquiry 302 under the conditions specified by a user terminal device 211 for the database 223 of multiple medical image systems 221 of multiple medical treatment facilities on a wide-area network. When an image data inquiry 302, which was sent from a user terminal substitution device 325, is received, the database 223 of medical treatment facilities 202, 203, and 204 is searched to determine whether image data matching the conditions of the inquiry is stored in data archiving device 222, and a response is sent to the user terminal substitution device 325 in the form of an inquiry response 303 containing the searched results. The user terminal device 325 then sends to the user terminal device 211 this response as a concluding response 304. The user terminal device displays the response 304, the image data of the desired examination is selected by the doctor in charge, and an image data acquisition request 305 is issued together with image data processing parameters 309 by the user terminal substitution device 325. The user terminal substitution device 325 sends the image acquisition request and image processing parameters 310 to a data processing device in the vicinity of a data archiving device 222 in which image data of the specified examination is stored. For example, if a desired PET scan image data is stored in the data archiving device 222 of medical image system 221 of the medical treatment facility 202, the user terminal substitution device 325 sends an acquisition request 306 for the acquisition of the image data of a desired X-ray CT scan to the data processing device 224 of the medical image system 221 of the medical treatment facility 203, and an acquisition request 306 for the acquisition of the image data of a desired PET scan is sent to the data processing device 224 of the medical image system 221 of the medical treatment institution 203.

The data processing device 224 of the medical image system 221 at the medical treatment institution 202 acquires image data 308, sent to the data archiving device 222 with a transmission request 307 for the transmission of the image data of a specified CT scan. In response to that, image processing operations are conducted with image processing parameters 310 and the processing result 311 is sent to the user terminal substitution device 325. The data processing device 222 of the medical image system 221 of the medical treatment facility 203 acquires image data sent by the data acquisition device 222 with the transmission request 307 for the image data of the specified PET scan and in response to that, image processing operations are performed with image processing parameters 310 and the processing result 311 is sent to the user terminal substitution device. When the user terminal substitution device 325 has received this processing result 311, a processing result 312 is sent to the user terminal device 211 by the user terminal substitution device 325. Additional operations of the user terminal device 211 can thus be decreased by the substitution of the operation of the user terminal device 211 created in the user terminal substitution device 325.

### Second Alternative Embodiment

When it is requested by a user terminal device that desired image processing be carried out using multiple sets of medical image data which have been distributed to and stored in a data archiving device of one or more medical image systems on a network, image processing is performed using the data processing device of the medical image system in which this image data is stored, where various types of superimposition processing or fusion processing operations, etc., are applied with a user terminal device to multiple sets of image data containing processed images received from one ore more data processing devices, so that the result of these operations is sent with corrected image processing parameters to a data processing device and when the result of image processing operations is received with these corrected image processing parameters by a data processing device, a response is returned manually or automatically. Therefore, image diagnosis support operations, beginning with superimposition of multiple sets of image data, fusion processing and similar operation applied to multiple image data sets distributed to and stored in one or more medical image systems, can be conducted without increasing the traffic in the network.

### Third Alternative Embodiment

When a terminal user device performs image processing using multiple sets of medical image data that has been distributed to and stored in a data archiving device of one or more medical image systems on a network, image processing operations are performed using data processing devices of the medical image system in which the image data sets are stored, so that information is obtained from the result of various types of data processing operations performed with user terminal devices, applied to multiple image data sets containing processed images, received from one ore more data processing device. This information is sent to the relevant data processing devices and the parameters for processing of images used by data processing devices are changed by the determination at the data processing device. Because the result is returned when the information is received again, image diagnosis support operations such as superimposition processing or fusion processing or similar processing of multiple sets of image data distributed to and stored in one or more medical image data can be performed without increasing the network in the traffic.

### Fourth Alternative Embodiment

User terminal devices are used to perform desired image processing operations applied to multiple sets of medical image data stored in data archiving devices of one or more medical image system on a network, described in medical diagnosis reports created by medical imaging specialists, so that using data processing devices of a medical image system in which medical data is stored as described in medical image diagnosis reports, image processing operations are performed using image processing parameters described in image diagnosis reports, including mutual comparison of image data sets using multiple sets of image data with processed images received from one or more data processing devices. This makes it possible to refer to images using multiple sets of image data distributed to and stored in one ore more medical image systems.

Software to implement the technique introduced here may be stored on a machine-readable medium. A “machine-accessible medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, can include, for example, hardwired circuitry, programmable circuitry, software, or any combination thereof.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A medical image system on a wide-area network, comprising:
a data archiving device to store medical image data; and
a data processing device, coupled to the data archiving device, to receive from the data archiving device image data identified in a request sent by a user terminal device over the wide-area network, to generate medical images by processing the identified image data based on image processing parameters sent by the user terminal device over the wide-area network, and to transmit the medical images to the user terminal device over the wide-area network, without transmitting the identified image data to the user terminal device over the wide-area network.

2. A medical image system as recited in claim 1, further comprising:
means for transmitting, to the user terminal device, images resulting from processing performed by a data processing device belonging to another medical image system on the wide-area network.

3. A medical image system as recited in claim 1, further comprising:
a database to manage medical image data archived in the data archiving device;
means for searching the database in response to an inquiry obtained from the user terminal device; and
means for providing a result of the search as a response to the user terminal device.

4. A medical image system as recited in claim 3, further comprising:
means for allowing selection of one or more of the plurality of medical image systems based on the response obtained from the database and specification that image data be acquired from a data archiving device in a specified data processing device of a selected medical image system.

5. A medical image system as recited in claim 4, wherein the image diagnosis support operations include superimposition of images received from one or more of the data processing devices.

6. A medical image system as recited in claim 1, further comprising means for authenticating a user of the user terminal device.

7. A medical image system as recited in claim 1, further comprising a user terminal substitution device located in one of the medical image systems, the user terminal substitution device comprising means for making an inquiry, relating to image data archived in a data archiving device of a medical image system and applied to databases of a plurality of the medical image systems, based on instructions received from a user terminal device.

8. A networked image processing system for medical image data, the networked image processing system comprising:
a plurality of medical image systems connected at different locations to a wide-area network, each of the medical image systems including a data archiving device storing medical image data and a data processing device coupled to the data archiving device;
means for receiving, at any of the medical image systems, image processing parameters and information specifying image data to be retrieved from a data archiving device, sent from a user terminal device via a wide-area network; and
means for enabling image diagnosis support operations to be performed at the user terminal without transmitting all of said specified image data to the user terminal through the wide-area network, by transmitting to the user terminal device, via the wide-area network, images that result from at least one of the data processing devices processing the specified image data based on the image processing parameters.

9. A networked image processing system as recited in claim 8, further comprising:
means for transmitting, to the user terminal device, images resulting from processing performed by data processing devices at two or more of the plurality of medical image systems.

10. A networked image processing system as recited in claim 9, wherein the image diagnosis support operations include mutual comparison of a plurality of images received from the two or more data processing devices.

11. A networked image processing system as recited in claim 9, wherein the image diagnosis support operations include superimposition of images received from the two or more of the data processing devices.

12. A networked image processing system as recited in claim 9, wherein the image diagnosis support operations include fusion of images received from the two or more of the data processing devices.

13. A networked image processing system as recited in claim 9, further comprising:
a database to manage the data archived in the data archiving device;
means for searching the database in response to an inquiry obtained from the user terminal device; and
means for providing a result of the search as a response to the user terminal device.

14. A networked image processing system as recited in claim 13, further comprising:
means for allowing selection of one or more of the plurality of medical image systems based on the response obtained from the database and specification that image data be acquired from a data archiving device in a specified data processing device of a selected medical image system.

15. A networked image processing system as recited in claim 14, wherein the image diagnosis support operations include superimposition of images received from one or more of the data processing devices.

16. A networked image processing system as recited in claim 9, further comprising means for authenticating a user of the user terminal device.

17. A networked image processing system as recited in claim 8, further comprising a user terminal substitution device located in one of the medical image systems, the user terminal substitution device comprising means for making an inquiry, relating to image data archived in a data archiving device of a medical image system and applied to databases of a plurality of the medical image systems, based on instructions received from a user terminal device.

18. A method implemented in a networked image processing system for medical image data, method comprising:
receiving, at one of a plurality of medical image systems on a wide-area network, image processing parameters and information specifying image data to be retrieved from a data archiving device, sent from a user terminal device via the wide-area network; and
transmitting to the user terminal device, via the wide-area network, images that result from a data processing device at least one of the medical image systems processing the specified image data based on the image processing parameters, to enable image diagnosis support operations to be performed at the user terminal without all of said specified image data having to be transmitted to the user terminal through the wide-area network.

19. A method as recited in claim 18, further comprising:
transmitting, to the user terminal device, images resulting from processing performed by data processing devices at two or more of the plurality of medical image systems.

20. A method as recited in claim 19, wherein the image diagnosis support operations include mutual comparison of a plurality of images received from the two or more data processing devices.

21. A method as recited in claim 19, wherein the image diagnosis support operations include superimposition of images received from the two or more of the data processing devices.

22. A method as recited in claim 19, wherein the image diagnosis support operations include fusion of images received from the two or more of the data processing devices.

23. A method as recited in claim 18, further comprising:
searching a database for managing archived medical image data, in response to an inquiry obtained from the user terminal device; and
providing a result of the search as a response to the user terminal device.

24. A method as recited in claim 23, further comprising:
allowing selection of one or more of the plurality of medical image systems based on the response obtained from the database and a specification that image data be acquired from a data archiving device in a specified data processing device of a selected medical image system.

25. A method as recited in claim 24, wherein the image diagnosis support operations include superimposition of images received from one or more of the data processing devices.

26. A method as recited in claim 18, further comprising:
authenticating a user of the user terminal device.

27. A method as recited in claim 18, further comprising:
operating a user terminal substitution device located in one of the medical image systems, the user terminal substitution device comprising means for making an inquiry, relating to image data archived in a data archiving device of a medical image system and applied to databases of a plurality of the medical image systems, based on instructions received from a user terminal device.

28. An image processing system in a wide-area network environment, comprising:
a plurality of medical image systems set up in one or more medical treatment facilities and equipped with data processing devices coupled to data archiving devices, each of the plurality of medical image systems including:
a function enabling specification, with user terminal devices, of image processing parameters and image data to be acquired from data archiving devices of a medical image system in which desired image data is stored;
a function enabling transmission to user terminal devices, via a wide-area network, of image data containing the results of image processing after image processing operations have been executed with image processing parameters specified for the image data; and
a function enabling the user terminal devices to receive image data sent from two or more data processing devices containing processed images, to perform image processing operations including image superimposition, and to display the images containing the result of the image processing operations;
wherein image diagnosis support operations including mutual comparison of image data sets, distributed to and stored in the plurality of medical image systems, can be realized in a wide-area network environment by transmitting over the wide-area network images resulting from image processing operations by one or more of the data processing devices, without transmitting all of the specified image data upon which said images are based through the wide-area network.

29. An image processing system as recited in claim 28, wherein each of the medical imaging systems further includes:
a function enabling selection of one or more medical image systems based on a response obtained from a database to which the inquiry was sent, and to specify that image data be acquired from a data archiving device in a specified data processing device of a selected medical image system.

30. An image processing system as recited in claim 28, wherein at least one of the medical imaging systems further includes a user terminal substitution device to make an inquiry relating to image data archived in a data archiving device of a medical image system, applied to the database of a plurality of medical image systems on a network, based on instructions obtained from a user terminal device.
